(19) United States
(12) Patent Application Publication
(10) Pub. No.: US 2024/0359146 A1
(43) Pub. Date: Oct. 31, 2024

(54) PORTABLE CARBONATING DISPENSERS

(71) Applicant: Cirkul, Inc., Tampa, FL (US)

(72) Inventors: Garrett Waggoner, Tampa, FL (US); Andrew Gay, Tampa, FL (US); Thomas A. Urbanik, Watertown, MA (US); Corey Jerolmon, Boston, MA (US); Cole Houston, Central Falls, RI (US)

(73) Assignee: Cirkul, Inc., Tampa, FL (US)

(21) Appl. No.: 18/766,868

(22) Filed: Jul. 9, 2024

Related U.S. Application Data
(63) Continuation of application No. 17/377,259, filed on Jul. 15, 2021, now Pat. No. 12,076,697.
(60) Provisional application No. 63/052,348, filed on Jul. 15, 2020.

(51) Int. Cl. B01F 23/2361; A23L 2/54; B01F 23/237; B01F 33/501

(52) U.S. Cl. CPC B01F 23/23611; A23L 2/54; B01F 33/50111; A23V 2002/00; B01F 23/23762; B01F 23/237621

(57) ABSTRACT

A portable carbonating dispenser utilizes an onboard supply of carbonation gas and a carbonation control module for permitting a user to carbonate base liquid stored in an onboard base liquid container. The carbonation control module may include a user actuated button for selectively activating the carbonation. The base liquid container may include an extended portion for increasing the exposure of base liquid to carbonation gas. A vertical viewing window enables a user to view carbonation and the level of base liquid in the container. An isolation component may be useful to isolate an additive cartridge from carbonation pressure during carbonation in applications where the dispenser utilizes additive cartridges. Safety venting and locking features may be provided on the mode selector to prevent a user from accidentally pressurizing the cartridge space. A refill station may be provided to refill the portable carbonating dispenser.

### PRIORITY CLAIM

Priority is claimed to U.S. Provisional Application 63/052,348, titled PORTABLE CARBONATION SYSTEM, filed on Jul. 15, 2020, which is incorporated by reference herein in its entirety.

### FIELD

This disclosure relates generally to beverage forming and dispensing apparatus, systems and associated methods. Such apparatus, systems and methods may provide portable (i.e., handheld) beverage dispensers with onboard, user-controlled carbonation features and may utilize cartridges for adding additives, such as flavorings or supplements, to a base liquid as the base liquid is dispensed. These apparatus, systems and methods may further relate to refill stations for refilling an onboard supply of carbonation gas on a portable carbonating dispenser.

### BACKGROUND

Recent advances in the art include beverage forming and dispensing systems that may utilize replaceable cartridges that mix additive with the dispensed base liquid (water). These systems may mix flavoring or other additives with a base liquid (water) as the base liquid is dispensed from a container. Examples of such systems are described in U.S. Pat. No. 10,888,826, granted Jan. 12, 2021, titled ADJUSTABLE ADDITIVE CARTRIDGE SYSTEMS AND METHODS, and US Published Patent Application US20190291065A1, titled ADJUSTABLE ADDITIVE DELIVERY SYSTEMS AND DISPENSING CLOSURE VALVES FOR THE SAME, published on Sep. 26, 2019, both documents of which are incorporated by reference herein in their entirety.

Systems and methods for carbonating beverages are known in the art. For example, tabletop soda preparation systems that permit a user to carbonate their own beverages are known. However, known systems and techniques are not particularly suited for portable beverage dispensers. Moreover, multiple use beverage forming and dispensing systems that may utilize replaceable additive cartridges present additional challenges with regard to adapting carbonation systems and techniques in these environments. There is a need in the art for improvements that address these challenges and others.

### SUMMARY

Aspects of the disclosure provide portable (i.e., handheld) carbonating dispensers with onboard carbonation features and components that are modular and suitable for integration while permitting a compact form factor for the dispenser. For example, in some embodiments, a portable carbonating dispenser may include a compact, portable arrangement of an onboard base liquid container, an onboard carbonation module, which may include a carbonation gas container or container and a carbonation flow control assembly, all arranged compactly in an ergonomic housing. A base liquid container closure may sealingly engage the base liquid container such that the interior thereof may be pressurized for carbonation. The onboard base liquid container may be shaped with an alcove or recess to permit compact arrangement of the carbonation gas container. The carbonation flow control assembly may include flow and pressure control components integrated into a module disposed in a base of the housing for ease of assembly and compactness and may include a user-actuated flow control component, including a button, accessible from the housing exterior, for controlling the flow of carbonation gas into the base liquid supply contained in the base liquid container and thus the level of carbonation. The carbonation flow control assembly may include a refill connection for receiving refill carbonation gas from a refill station supply to refill the onboard carbonation gas container. The portable carbonating dispenser permits a user to carbonate a base liquid to a desired level within the dispenser itself in portable fashion and without the need for larger (i.e., tabletop) carbonation system. The portable carbonating dispenser also permits refilling of base liquid and carbonation gas for multiple uses for carbonating and dispensing carbonated water or a carbonated beverage.

Aspects of the disclosure provide portable carbonating dispensers with features for isolating a dispensing passage from exposure to carbonation pressure during carbonation. For example, in some embodiments, a portable carbonating dispenser may include base liquid container closure having a dispensing passage therein and having an isolating component, which may be integrated into the base liquid container closure, for isolating the dispensing passage from the base liquid supply and base liquid container interior to facilitate pressurization of the base liquid container and carbonation of the base liquid. In one embodiment, the isolating component may include a closure insert that may be actuated with a mode selector lever on the closure to configure the portable carbonating dispenser to a carbonation mode or a dispensing mode. The insert may rotate within a journal formed in the container closure and may have one or more insert ports and blocking surfaces which cooperate with respective journal ports to selectively block or align with the journal ports and selectively isolate the dispensing passage from the base liquid container interior (carbonation mode) or expose the dispensing passage to the base liquid container interior (dispensing mode). By operating the mode selector lever, the user may selectively configure the portable carbonating dispenser to carbonation mode or dispensing mode. The dispensing passage may be isolated and protected from exposure to the carbonation gas pressure in the base liquid container during carbonation.

Aspects of the disclosure provide carbonation features that are particularly suited to dispenser environments that utilize replaceable additive cartridges, which features may selectively isolate and protect the additive cartridge during carbonation operations. For example, in some embodiments, a portable carbonating dispenser may be used with an additive cartridge installed in the container or container closure, for example, in a cartridge receiving space in the container closure dispensing passage. The portable carbonating dispenser isolating component may thereby isolate the additive cartridge and protect it against exposure during carbonation mode and may permit base liquid to flow into the dispensing passage and through the cartridge in a dispensing mode. In one embodiment, the isolating component may include a closure insert that may be actuated with a mode selector lever on the closure to configure the portable carbonating dispenser to a carbonation mode or a dispensing mode. The insert may rotate within a journal formed in the container closure and may have one or more insert ports and blocking surfaces which cooperate with respective journal ports to selectively block or align with the journal ports and selectively isolate the additive cartridge from the base liquid container interior (carbonation mode) or expose the dispensing passage to the base liquid container interior (dispensing mode). By operating the mode selector lever, the user may selectively configure the portable carbonating dispenser to carbonation mode or dispensing mode. The additive cartridge may be isolated and protected from exposure to the carbonation gas pressure in the base liquid container during carbonation.

Aspects of the disclosure provide features to enhance carbonation within a portable carbonating dispenser base liquid container. In some embodiments, portable carbonating dispensers may include features for enhancing carbonation. In one embodiment, the onboard base liquid container may be provided with an asymmetrical shape, including an extended portion or well, which contains a deep column of supply liquid of greater depth than other portions of the base liquid container. A carbonation gas injector or nozzle may be disposed at the bottom of the base liquid container extended portion such that carbonation gas undergoes prolonged exposure to the base liquid supply while traveling in the extended portion, thereby enhancing carbonation.

Aspects of the disclosure provide simplified user operation and control of carbonation on a portable carbonating dispensers. In some embodiments, the portable carbonating dispenser may be provided with additional features for preventing the dispensing passage and additive cartridge, if present, from exposure to carbonation pressure during a carbonation operation. For example, the closure may be provided with a vent that may be actuated to vent pressure from the base liquid container following a carbonation operation and before the portable carbonating dispenser is configured to a carbonation mode. The vent may be a push button valve located on the container closure. Moreover, the mode selector lever may be provided with a ramped or other surface for actuating the vent push button valve as the mode selector lever is moved from a carbonation mode position to a dispensing mode position. Venting of the base liquid container may thus occur automatically when the user operates the mode selector lever such that any residual carbonation pressure in the base liquid container is vented prior to the user dispensing base liquid from the container for consumption.

In some embodiments, the portable carbonation dispenser may be provided with other features for preventing exposure of the dispensing passage and additive cartridge, if present, to carbonation pressure. For example, the closure may be provided with a carbonation level indicator, which may be a spring biased post or flag that is extended upward by base liquid container pressure when the base liquid supply is pressurized. The indicator may then visually indicate to the user that the base liquid supply is under pressure. According to a further aspect, the mode selector lever may be provided with a stop tab that is arranged to engage the carbonation level indicator post or flag to thereby prevent movement of the mode selector lever from a carbonation position when the base liquid container is under pressure. This feature, particularly in combination with the vent, provides additional protection against the dispensing passage and additive cartridge, if present, being exposed to excessive pressure from the base liquid container. According to a further aspect, the container closure may be provided with a relief valve to ensure that the base liquid container pressure never exceeds a threshold safety level. The relief valve may also permit the user to control carbonation by ensuring that the carbonation pressure stays at a substantially constant value during carbonation.

According to another aspect, the portable carbonating dispenser includes user interface features for assisting the user in performing the carbonation operation. For example, an elongate, axially extending viewing window may be provided on the base liquid container and arranged to extend through the portable carbonating dispenser housing such that the interior of the base liquid container and the contained base liquid is visible to the user. The viewing window may be located above the user actuated carbonation button on the housing. A carbonation gas nozzle may be located such that carbonation bubbles are visible through the viewing window during a carbonation operation. These features may provide the user with a visual indication that carbonation is occurring within the base liquid container. In another embodiment, the container closure may be provided with an alignment projection for aligning the mode selector lever therewith to indicate to the user that the lever is in a carbonating mode position or a dispensing mode position.

According to another aspect, a container lid or closures are provided with features for supporting carbonation within an associated container. In one embodiment, the container closure may comprise a closure base having a journal, the journal including at least one journal port defined therein, a closure insert disposed in closure base journal and having a closure insert wall defining a cartridge receiving space, the closure insert wall having least one insert port and at least one blocking surface defined thereon, the closure insert being adapted to rotate within the journal to a carbonation position in which the at least one blocking surface blocks the at least one journal port to isolate the cartridge receiving space; the closure insert being adapted to rotate to a dispensing position in which the at least one insert is aligned with the at least one journal port to permit flow into the cartridge receiving space.

According to another aspect, some embodiments provide a method of preparing a carbonated beverage in a portable carbonation system. The portable carbonation system may comprise an onboard base liquid container, a container closure including a dispensing passage, a gas container for containing a supply of carbonation gas, a carbonation flow control assembly, the carbonation flow control assembly including a user-actuated flow control component for controlling the flow of carbonation gas to the base liquid supply, and an isolating component for permitting a user to selectively isolate the dispensing passage and thereby prevent pressurization of the dispensing passage when the base liquid supply is pressurized by the carbonation gas. The method may comprise filling the onboard base liquid container on the portable carbonation system with a base liquid supply, operating the isolation component to isolate the dispensing passage from the base liquid container; and carbonating the base liquid supply with gas from the onboard gas container. The method may further comprise securing a cartridge to the container closure and isolating the cartridge from the base liquid container during the step of carbonating the base liquid supply. The method may further comprise operating the isolating component to configure the portable carbonating dispenser to a dispensing mode after carbonating the base liquid supply. The method may further comprise operating a vent on the container closure to vent pressure from the base liquid supply after carbonating the base liquid supply. The method may further comprise operating a mode selector lever on the container closure to operate the isolation component. The method may further comprise operating a vent by moving the mode selector lever.

Aspects of the disclosure provide multiple use portable carbonating dispensers that may be refilled with carbonation gas from a refill station. According to a further aspect, the portable carbonating dispenser may be used in conjunction with a refill station. The refill station may include a housing for supporting components of the refill station, a refill gas container disposed in the housing, a portable carbonating dispenser interface for connecting a portable carbonating dispenser to the refill station and for permitting flow of gas from the refill gas container to the portable carbonating dispenser, and a refill gas flow control assembly including a flow control valve for controlling the flow of gas from the refill station gas container to the portable carbonating dispenser interface; the refill gas flow control assembly further including a user-actuated lever for selectively operating the flow control valve. In some embodiments, the portable carbonating dispenser may be refilled (recharged with carbonation gas) using a refill station. The refill station may include a dispenser dock for supporting the portable carbonating dispenser. The dispenser dock may have an alignment recess for receiving and centering the container bottom such that a quick connect fitting is aligned with and engages a refill station connection fitting on a dispenser carbonation control module. A lock release button on the dispenser dock may permit locking and release of the quick connect fitting with the refill station connection fitting. A refill gas container 510 may be arranged and adapted to contain liquified or a gaseous form of carbonation gas, such as carbon dioxide. Carbonation gas is supplied to a refill valve from the refill gas container. A user may actuate the refill valve using an actuation lever once the portable carbonating dispenser is locked in place. During a refill operation, carbonation gas is thus supplied from the refill gas container to the portable carbonating dispenser through an onboard gas container refill manifold in the onboard carbonation gas flow control assembly to the onboard gas container. During refill, pressure in the onboard gas container may be controlled using a relief valve on the container closure which may provide an audible indication to the user that the onboard container has been completely refilled.

According to a further aspect, some embodiments provide a method of refilling a portable carbonating dispenser using a refill station. The refill station may comprise a housing, a refill gas container disposed in the housing, a portable carbonating dispenser interface for connecting a portable carbonating dispenser to the refill station and for permitting flow of gas from the refill gas container to the portable carbonating dispenser, and a refill gas flow control assembly including a flow control valve for controlling the flow of gas from the refill station gas container to the portable carbonating dispenser interface, the refill gas flow control assembly further including a user-actuated lever for selectively operating the flow control valve. The method may comprise securing the portable carbonation system to the refill station, filling an onboard gas container on the portable carbonation system from the refill gas container, removing the portable carbonation system from the refill station, carbonating the base liquid supply with gas from the onboard gas container, resecuring the portable carbonation system to the refill station, and refilling the onboard gas container from the refill gas container.

The preceding aspects and embodiments are summary examples. These and other aspects and embodiments will be more apparent from the following description, including the drawings, and claims. Unless otherwise defined, all technical and scientific terms used herein have the same meaning as commonly understood by one of ordinary skill in the art to which the described invention pertains. While suitable, example implementations are described below, other implementations, similar to those described herein can be used to practice the invention. All publications, patent applications, and other references mentioned herein are incorporated by reference in their entirety. In case of conflict, the present specification, including definitions, will control. In addition, the examples described herein are illustrative only and are not intended to be limiting in any way. The details of one or more example implementations of the invention are set forth in the accompanying drawings and the description below. Other features, objects and advantages of the invention will be apparent from the description and drawings, and from the claims.

### DESCRIPTION OF THE DRAWINGS

The above and other attendant advantages and features of the invention will be apparent from the following detailed description together with the accompanying drawings, in which like reference numerals represent like elements throughout. It will be understood that the description and embodiments are intended as illustrative examples and are not intended to be limiting to the scope of invention, which is set forth in the claims appended hereto. The following Figures, unless otherwise indicated, illustrate example apparatus, systems or methods in illustrative embodiments and according to aspects of the disclosure.

FIG. 1 is a front perspective view of an example portable carbonating dispenser;

FIG. 2 is an exploded front perspective view of the FIG. 1 example;

FIG. 3 is an exploded rear perspective of the FIG. 1 example;

FIG. 4 is a cross-section of a housing, base liquid container, carbonation module and other components illustrated in FIGS. 1-3, the cross-section being taken in plane 4-4 in FIG. 2;

FIG. 5 is front perspective of a carbonation flow control assembly of the portable carbonating dispenser of FIGS. 1-4.

FIG. 6 is side perspective of the carbonation flow control assembly of FIG. 4;

FIG. 7 is a block diagram of components of a portable carbonating dispenser;

FIGS. 8.1 and 8.2 are schematic illustration of an example cartridge isolating component in a dispensing mode and isolating mode, respectively;

FIG. 9 is side perspective view of a container closure featuring an cartridge isolating component;

FIG. 10 is a side perspective view of the container closure of FIG. 9 with a handle and shroud assembly removed to illustrate additional features;

FIG. 11 is an exploded side perspective view of the container closure of FIGS. 9 and 10;

FIG. 12 is an exploded side perspective of the container closure of FIGS. 9-11;

FIG. 13 is a flow chart of a method of using a portable carbonating dispenser;

FIG. 14 is front perspective of a portable carbonating dispenser in a refilling position on a refill station;

FIG. 15 is a cross-section of the portable carbonating dispenser and refill station of FIG. 14;

FIG. 16 is a block diagram of components of a refill station; and

FIG. 17 is a flow chart of a method of refilling a portable carbonating dispenser.

### DETAILED DESCRIPTION

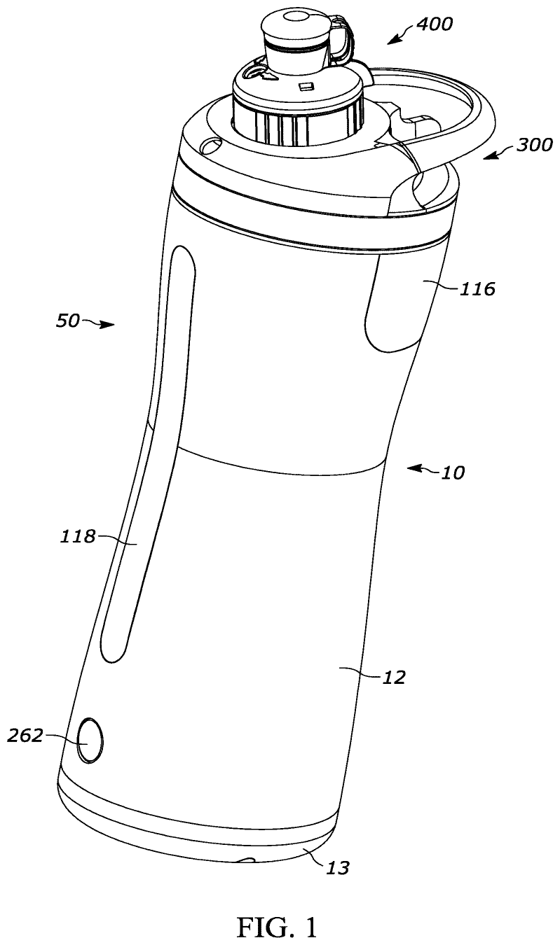

An example portable carbonating dispenser according to aspects of the disclosure is illustrated in FIGS. 1-11. Referring more particularly to FIGS. 1-3, the portable carbonating dispenser 50 may include the following main components: a housing 10, base liquid container 100, carbonation module 200, and closure 300, which may receive an additive cartridge 400. Base liquid container 100 and carbonation module 200 may be installed in a compact manner within housing 10. Housing 10 may include an outer wall 12 having a generally cylindrical or hourglass ergonomic shape suitable for user gripping, and a separate housing base 13, which may be removably secured to a bottom portion of housing 10. Outer wall 12 and housing base 13 may define an interior space 14 for housing other system components. Housing 10 may include an elongate, axially extending viewing window cutout 18, which may receive a complementary-shaped, transparent base liquid container viewing window 118 formed on the base liquid container 100 to permit a user to view the interior thereof. Housing 10 may further include a button cutout 20 for receiving a carbonation control button 262 on carbonation module 200. The carbonation control button 262 may be recessed within the housing 10 in order to prevent inadvertent actuation. A recessed top portion 16 of housing 10 may receive and align with a complementary-shaped, circumferentially extending overhang 116. These complementary fitting elements may provide a secure fit, aid in positioning during assembly, and add to the visually interesting effects of the overall portable carbonating dispenser 50. An internally threaded top end 120 of the base liquid container 100 may receive and secure an externally threaded base 310 of closure 300, which may include an O-ring seal adapted to sustain pressure in the base liquid container 100.

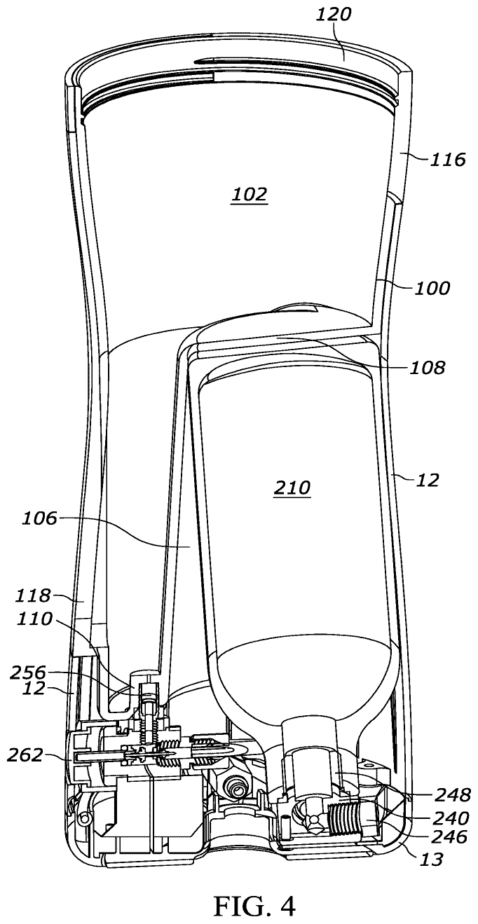

Housing interior space 14 may accommodate a base liquid container 100 for containing a supply of base liquid, such as water, or other beverage precursor liquid. Base liquid container 100 may include an interior chamber 102 having an asymmetrical shape, which advantageously improves carbonation of the base liquid. More particularly, interior chamber 102 may include an extended section or well 104 which has an increased depth. A carbonation gas nozzle receptacle 110 may be located beneath the base liquid container extended section 104 and may receive a carbonation nozzle 256 of carbonation flow control assembly 220. A small passage in the carbonation gas nozzle receptacle permits a flow of carbonation gas to introduced to the base liquid in a bottom portion of the extended section 104. Extended section thus provides for extended exposure of base liquid to carbonation gas as carbonation gas travels upward through the extended depth of base liquid, thereby increasing the level of carbonation achieved compared to base liquid container without this feature, for example. In addition, as best shown in the cross-section in FIG. 4, the asymmetric shape of the base liquid container 100, including the extended section 104 and an intermediate floor 108, may define an alcove or recess 106, which may accommodate an onboard carbonation gas container 210 and provide for compact arrangement of the carbonation gas container 210 and base liquid container 100 within the housing 10.

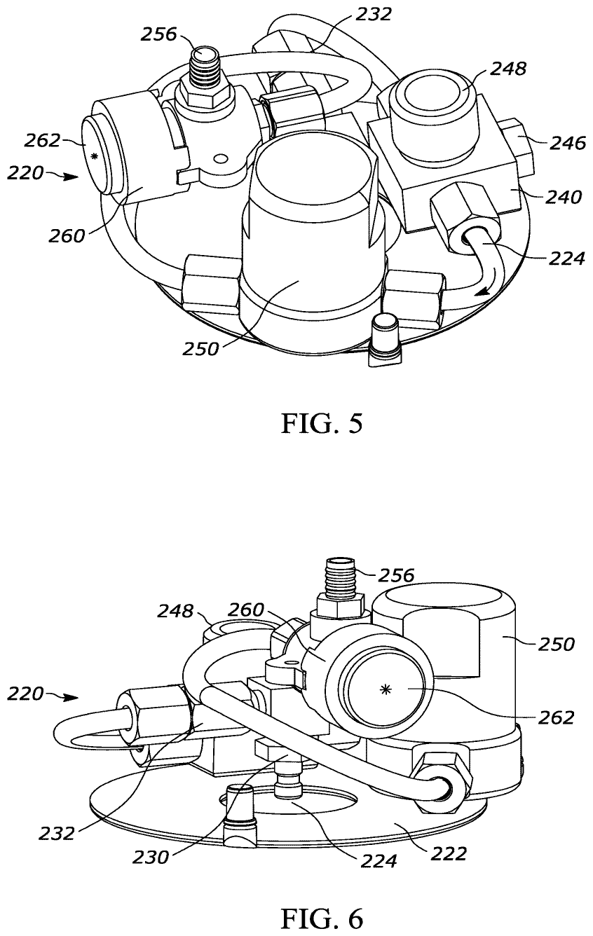

Referring more particularly to FIGS. 5-7, carbonation module 200 may include an onboard carbonation gas container 210 and a carbonation gas flow control assembly 220, which may comprise components for controlling the flow and pressure of carbonation gas delivered to the base liquid contained in the base liquid container 100 and which may provide for refilling of the carbonation gas container 210 from an external refill station, as will be described. Carbonation module 200 may be a compact module that is adapted and arranged to fit within the housing 10 with one or more components, disposed in a lower portion of the housing 10 and secured to a floor panel 222 which may be mounted to the container base 13. This arrangement provides for ease of assembly of the portable carbonating dispenser as the carbonation module can be preassembled prior to being inserted as a unit in the housing 10.

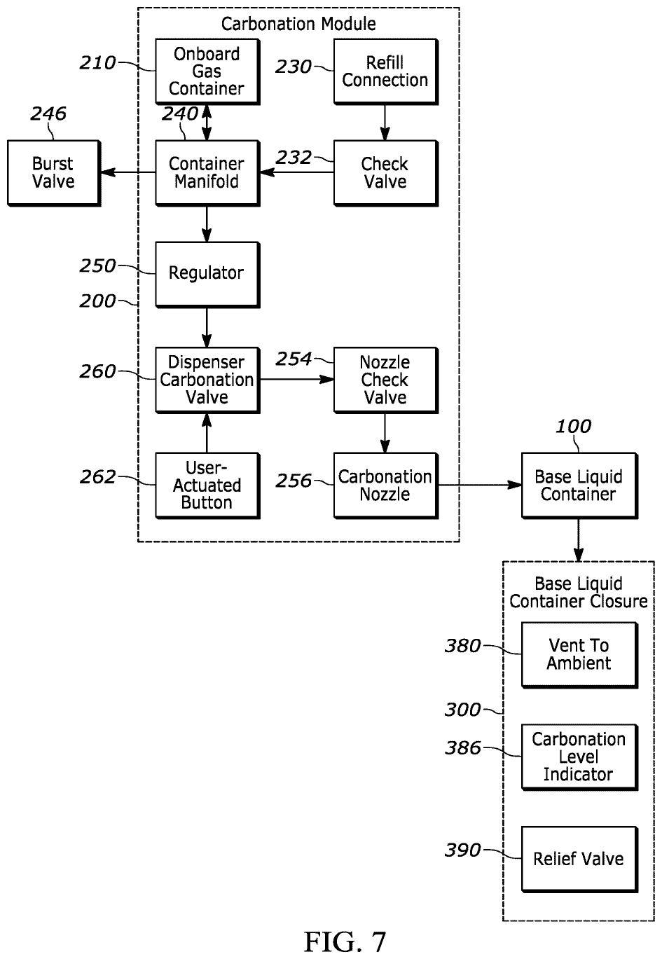

Carbonation gas flow control assembly 220 may include a refill connection fitting 230 disposed in a circular recess 224 in floor panel 222 to allow for alignment of the refill connection fitting with mating components on a refill station. FIG. 7 illustrates example fluid (gas) circuitry and interconnections between components of the carbonation module 200. Physically, these components may be connected with suitable tubing for conveying carbonation gas between components. Refill connection fitting 230 may receive refill carbonation gas, which then flows through a check valve 232, which prevents backflow. Carbonation gas then flows through a container 4-port manifold 240, which may contain an onboard gas container fitting 248 (see FIG. 4 additionally) for interfacing with the onboard gas container 210. Container manifold 240 thus permits refill into and outflow from the onboard gas container 210. Container manifold 240 may also include an integrated burst disk 246, which functions as a safety relief valve against excessive pressure in the onboard gas container 210 and other components in the circuit. Container manifold 240 also conveys gas from the onboard gas container 210 to a pressure regulator 250, which may modulate (i.e., maintain a constant pressure) in the circuit downstream of the regulator 250 and in carbonation gas provided to a dispenser carbonation valve 260, which may be actuated by a user push button to permit carbonation gas to flow through a nozzle check valve 254 and to the carbonation nozzle 256 to thereby provide carbonation gas flow into the base liquid container 100 and base liquid contained therein. Carbonation module 200 thus permits a user to provide a desired level of carbonation to the base liquid by activation of the user-actuated button 262.

FIG. 7 illustrates additional components that may be included in a base liquid container closure or lid 300. Closure 300 provides a suitable seal of the base liquid supply in order to permit the interior of the base liquid container 100 to be pressurized to sufficient levels to cause carbonation gas to be dissolved in the base liquid. Closure 300 may also include components for controlling and indicating (sensing) carbonation pressure within the base liquid container 100. These components may include a vent (to ambient) 380, a carbonation level indicator 386 and a relief valve 390. The function of these components will be explained in more detail subsequently in this disclosure.

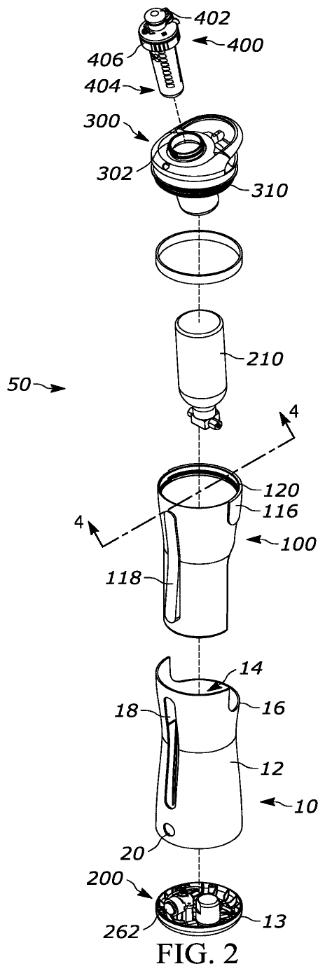

Carbonation systems according to the disclosure may be particularly adaptable to dispensers that utilize replaceable additive cartridges. For example, closure 300 may provide for the installation of a replaceable flow-through additive cartridge 400. Such cartridges 400 may include features similar to those described in the above-referenced U.S. Pat. No. 10,888,826. Cartridge 400 may be installed in a dispensing passage of a container lid or closure and may have a configuration and features that cause additive to be mixed with base liquid as the base liquid flows through the cartridge. Such a cartridge may also provide user adjustment of the amount of additive added to the base liquid flow by rotation of a flavor dial on the cartridge. Referring to FIGS. 2-4 of this disclosure, cartridge 400 may have a dispensing spout 402, an opposite inlet end 404 having one or more passages to permit the inflow of base liquid, and a threaded base 406 for securing the cartridge 400 to a threaded dispensing passage 302 in closure 300.

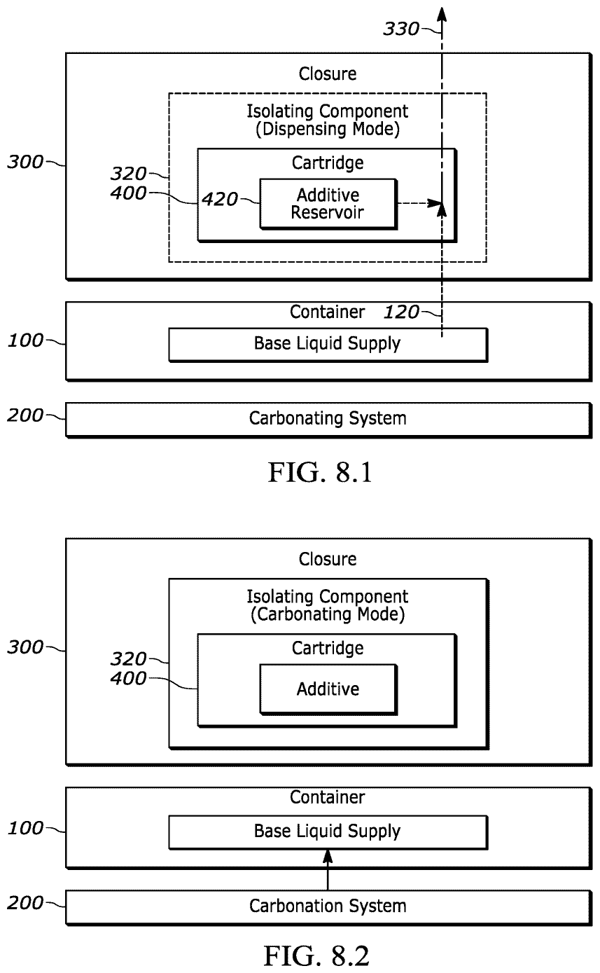

According to aspects of the instant disclosure, features are provided to support carbonation in dispenser environments that include additive cartridges described above. More particularly, features are provided for isolating the additive cartridge from the base liquid supply and accompanying higher pressures within the base liquid container during carbonation. It will be understood that the isolating component described herein also isolates the dispensing passage 302 of closure 300 and may be utilized as such in cases (i.e., where a user is carbonating and dispensing only water in the portable carbonating container) where an additive cartridge is not in use or present in the dispensing passage 302. FIGS. 8.1 and 8.2 schematically illustrate an isolation component arrangement, in which features may be provided a container closure 300 to provide for selective isolation of an additive cartridge (or dispensing passage, which may be assumed to be represented by the same block 400) during a carbonation operation in a portable carbonating dispenser. An isolating component 320 may provide a selectively permeable barrier which, in a dispensing mode (FIG. 8.1), is arranged and adapted to expose the cartridge to base liquid flow and permit dispensing operation of the container closure 300 in which a flow (long dashed line) 120 of base liquid results in additive flow 420 (short dashed line) and a mixed flow 330 (short/long dashed line) from the cartridge spout. In this mode the isolation barrier is permeable, represented by the dotted line defining the isolation component 320. Isolating component 320 may be configured to a carbonation mode (FIG. 8.2) in which the permeable barrier is arranged and adapted to isolate the cartridge from the base liquid supply and container such that the cartridge 400 is not exposed to carbonation pressure developed therein by the carbonation module 200. In this mode, the isolation barrier is impermeable and able to isolate the dispensing passage from pressure in the base liquid container 100, represented by the solid line defining the isolation component 320.

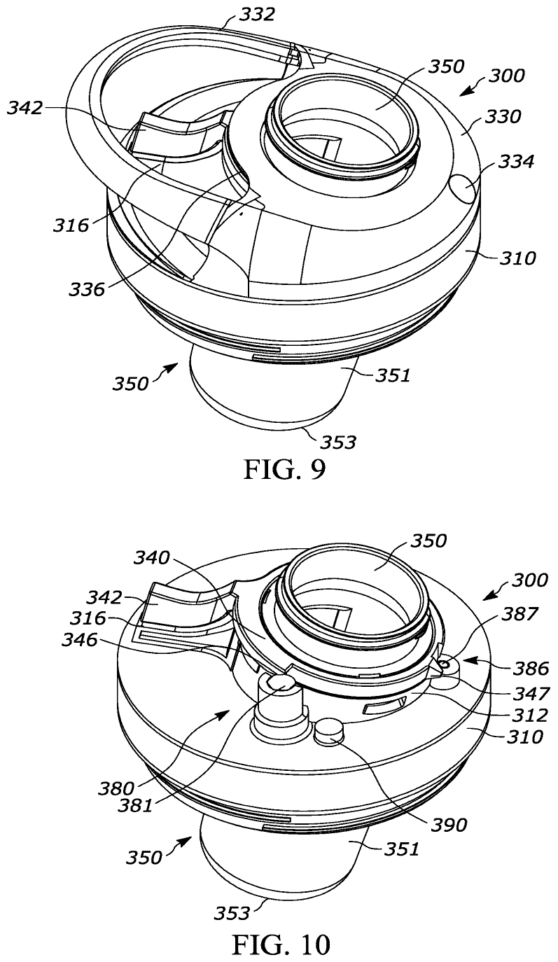

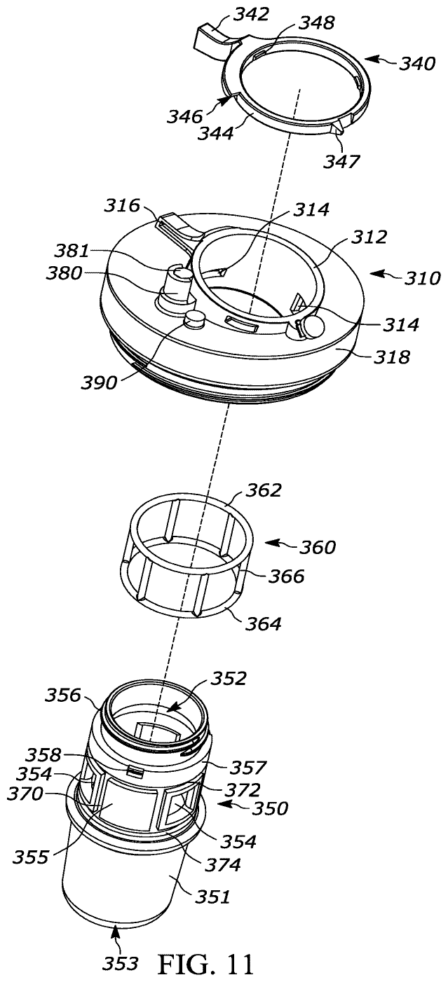

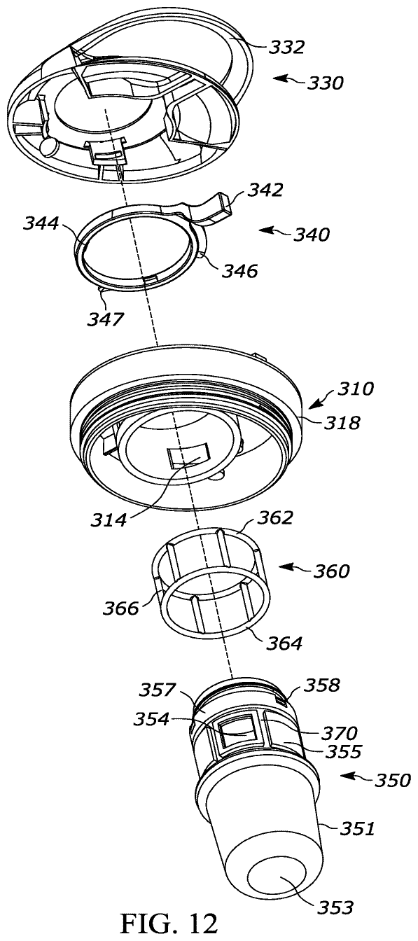

According to further aspects of this disclosure, an example implementation of an isolation component may be provided in a container closure 300 as illustrated in FIGS. 9-11. Major components of the closure 300 may include a closure base 310, closure shroud 330, a closure insert 350, insert seal 360 and actuating lever 340. FIGS. 9 and 12 show the closure shroud 330 whereas FIGS. 10 and 11 omit the closure shroud for clarity. Closure shroud 330 may include an integrated handle 332. Closure base 310 may include an annular journal 312 for receiving the closure insert 350 and one or more journal ports 314, which are arranged to permit flow of base liquid from the base liquid container interior to the interior of journal 312. Two journal ports 314 are shown in FIG. 11 (a third is hidden from view). Closure base 310 may include a vent 3, which may be a spring biased button 381 adapted to release pressure in the base liquid container when depressed relative to the closure base 310 by a user or by a ramp surface 346 on the actuation lever 340, as will be further described subsequently in this disclosure. A relief valve 390 may also be included on the closure base 310 and may feature a poppet or other type valve that releases pressure when a threshold pressure is reached, and thus is capable of controlling and maintaining a limited pressure within the base liquid supply container. Closure base 310 may include an over-molded grip ring 318 to permit user gripping and removal or installation of the closure 300 relative to the base liquid container 100.

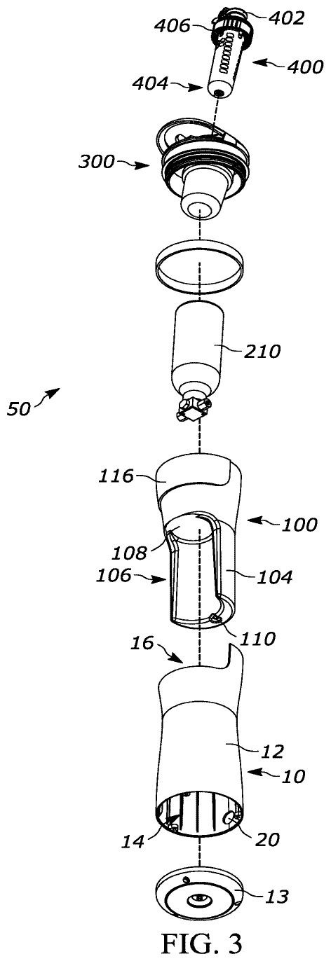

Closure insert 350 may include a cylindrical outer wall 351 extending to an end wall 353 to define an interior cartridge receiving space 352 for receiving an inlet end 404 (see FIGS. 2 and 3) of cartridge 400. Cartridge receiving space 352 also provides part of a dispensing passage, as will be recognized. A threaded end 356 of the insert 350 may engage the threaded cap 406 of cartridge 400 to secure the cartridge 400 to the insert. A number of snap fit recesses 358 may be provided on a cylindrical lever receiving surface 357 to secure a mode selector lever 340 to the closure insert 350 after assembly into the closure base 310. Closure insert 350 may include a number (in this case three) insert ports 354, which may permit flow of base liquid from the exterior into the interior cartridge receiving space 352. Interspersed between the insert ports 354 are a number of blocking surfaces 35. Insert 350 may include a seal retaining channel 370 having two circumferentially extending upper and lower segments 372 and 374, and a number of axially extending segments 376 extending between the upper and lower segments 372 and 374. Seal retaining channel 370 may receive a resilient (i.e., modified O-ring) insert seal 360 having a complementary shape with two rings 362 and 364 and a number of axially extending cross members 366.

As will be recognized from the instant disclosure, when closure insert 350 is installed and seated within the closure base journal 312, insert ports 354 and blocking surfaces 355 are arranged to cooperate with the journal ports 314 on the closure base 310. Rotation of the insert 350 to a dispensing position brings the insert ports 354 into alignment with the journal ports 314 and base liquid may thus flow to the interior cartridge receiving space 352. Rotation of the insert 350 to a carbonation position brings the blocking surfaces 355 into alignment with the journal ports 314 such that the interior cartridge receiving space 352, and thus an installed cartridge 400, is isolated from the base liquid container such that carbonation pressure may be applied therein without affecting the cartridge 400. In this example, the described features on the insert 350 and closure base 310 cooperate to provide an isolation component, which allows a user to selectively isolate the cartridge from pressure in the base liquid container 100. As will be recognized, insert seal 360 provides for sealing of the insert within the closure base journal 312 while rotation occurs. Insert seal 360 also provides for respective sealing engagement of each of the blocking surfaces 355 with the interior wall of closure base journal 312 and provide a seal that completely surrounds each of the journal vents 314 when the insert 350 is in a carbonation position, thus providing a seal against the relatively high pressure of the base liquid container 100 during a carbonation operation.

A mode selector lever 340 provides for user actuation (rotation) of the closure insert 350 to configure the closure 300 into a dispensing mode or carbonation mode. Mode selector lever 340 may include an actuation handle 342 and an annular ring 344 adapted to surround the lever engaging surface 357 of the insert 350 when installed thereon. The installed position of mode selector lever 340 on the insert 350 is best illustrated in FIG. 10. A number of snap-fit projections 348 may be provided on an interior surface of the annular ring 344 to engage a like number of snap-fit recesses 358 on the lever engaging surface 357 to provide ease of assembly and fastening of these components.

As best seen in FIG. 9, when the mode selector lever 340 and closure shroud 330 are installed on the closure base 310, the mode selector lever handle 342 may extend through a guide slot 336 in the closure shroud 330, which may guide and provide for limited movement (rotation) of the mode selector lever 340. An alignment projection 316 may extend from the closure base 310 and be contoured to fit with a like surface of the mode selector lever handle 342. Alignment projection may provide a visual and tactile indication of the mode selector lever handle 342 being in a carbonation mode, which is the position shown in FIGS. 9 and 10.

In accordance with aspects of the disclosure, the closure 300 may be provided with additional features to control carbonation pressure and ensure that the cartridge 400 is not exposed to carbonation pressure during operation. Closure 300 may be provided with an interlock feature which prevents a user from switching to a drinking mode if the base liquid supply is pressurized. In an illustrative embodiment, the mode selector lever 340 may be provided with a stop tab 347 (FIGS. 9-11) and the closure base 310 equipped with a retractable carbonation level indicator flag or post 387, which is positioned to project upward from the closure base 310 when suitable carbonation pressure is achieved in the base liquid container 100. Carbonation level indicator post 387 is shown in a retracted position within the container base 310 in FIG. 10. When the base liquid container is pressurized with carbonation gas, post 387 may extend upward and prevent movement of the stop tab 347 and thus prevent the user from switching the portable carbonating dispenser to a dispensing mode. As will be recognized, carbonation level indicator post 387 may be positioned to be viewed by a user through a transparent viewing lens 334 (FIG. 9) in the closure shroud 330.

According to a further aspect, the closure 300 may be provided with a vent 381 for venting pressure from the base liquid container 100. Vent 381 may be a push button type valve with an exposed actuation surface extending from the closure base 310 and housed within a pedestal on the closure base. The vent surface may be arranged and adapted to be engaged by a ramped surface 346 on the mode selector lever 340, which engages the surface and depresses the button as the mode selector lever 340 is rotated (counterclockwise in FIGS. 9 and 10). Vent 381 may thus ensure that pressure is vented to ambient/atmosphere from the base liquid container 100 as the user switches the dispenser to a dispensing mode and before the interior cartridge receiving space 352 of the insert 350 is exposed to the base liquid supply. Vent 381 may also be operated directly by the user (i.e., buy engaging the surface of vent 381 with a user's finger, thumb, a pencil point or other element) to vent any pressure build up within the base liquid container 100.

According to a further aspect of the disclosure, closure 300 may be provided with a relief valve 390 which may be set at a threshold pressure to limit the maximum pressure within the base liquid supply container. Relief valve 390 may be of a known construction, having a spring biased sealing element which is set to unseat and relieve pressure above a predetermined limit, typically 60 psi.

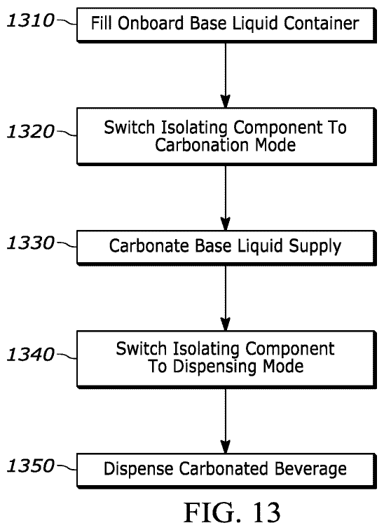

FIG. 13 illustrates steps in an example method for operating a portable carbonating dispenser such as that described above. At step 1310, a user may fill the base liquid container 100 and then secure the container closure 300. At step 1320, the isolating component is switched to a carbonation mode. At step 1330, the base liquid supply is carbonated by a user depressing the carbonation button 262 (FIG. 1) and thereby releasing carbonation gas from the onboard gas container 210 into the base liquid supply. At step 1340, the isolating component is then switched to a dispensing mode. This step may include intermediate steps of first venting pressure in the base liquid container. At step 1350, the carbonated beverage is then dispensed from the dispenser and may be flavored with additive from the cartridge as base liquid flows through the closure 300.

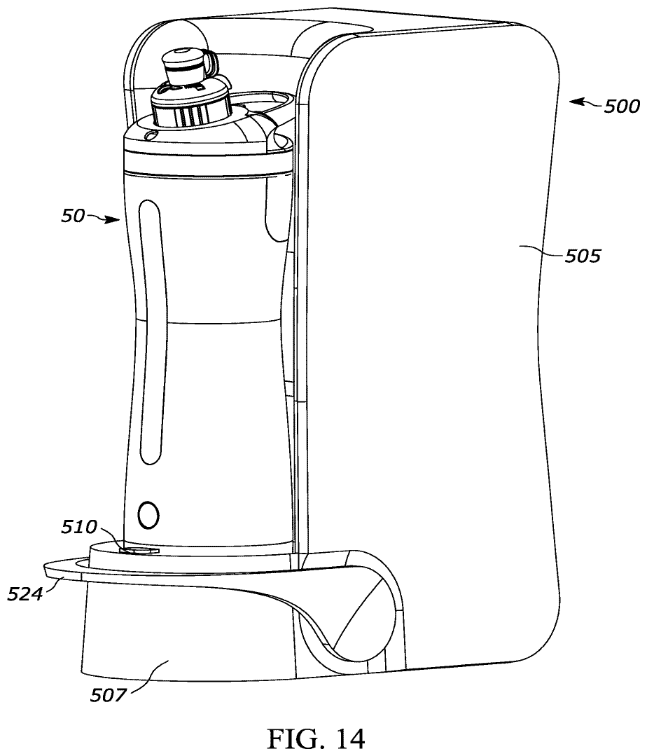

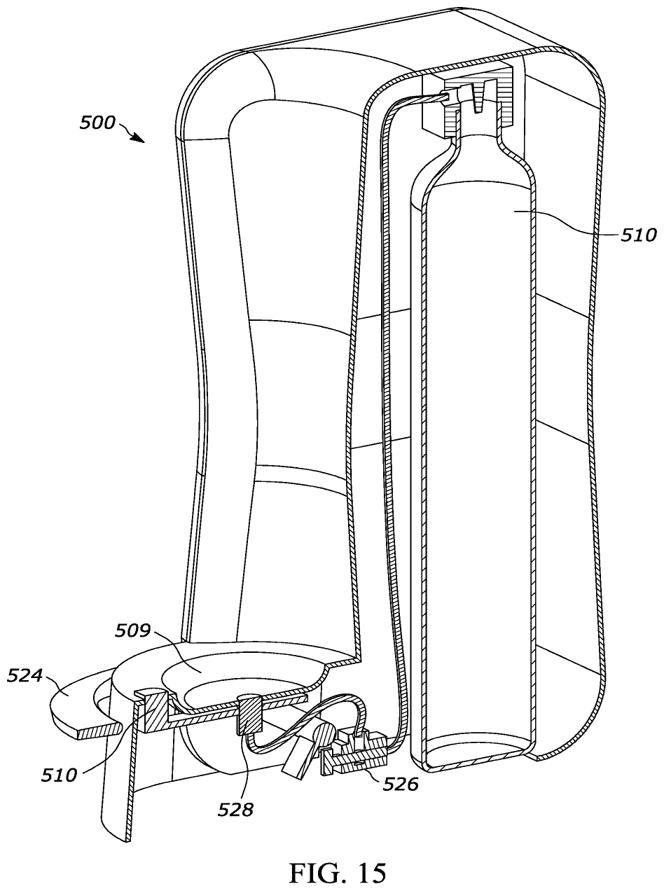

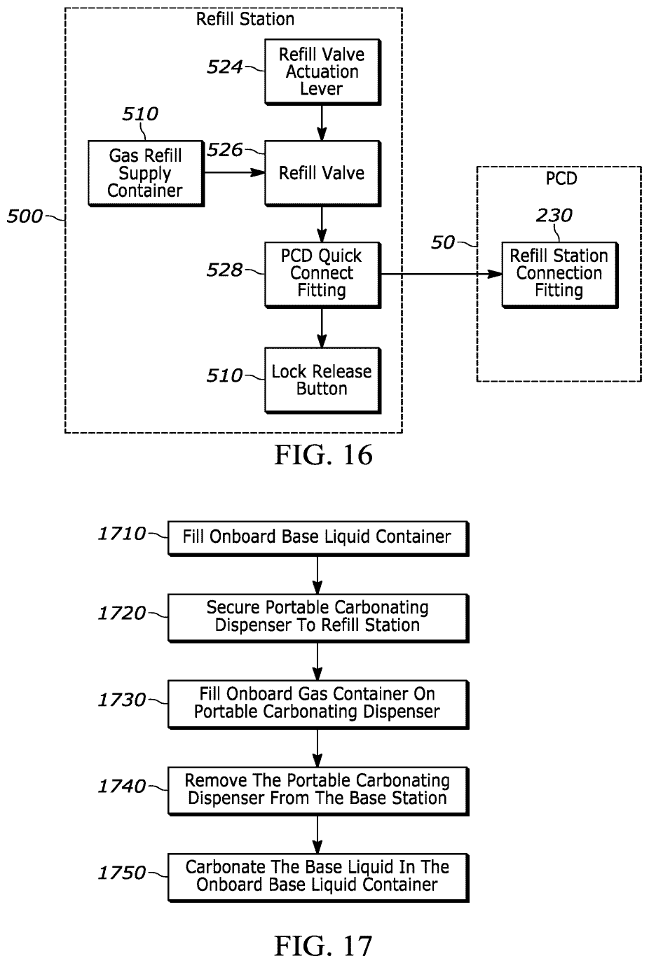

According to further aspects of the disclosure, the portable carbonating dispenser may be refilled (recharged with carbonation gas) using a refill station. An example refill station 500 arrangement is illustrated in FIGS. 14 and 15. FIG. 16 is a schematic representation of example components of a refill station and their functional relationships. The refill station 500 may include a main housing 505 for housing system components and having a dispenser dock 507 for supporting the portable carbonating dispenser 50. Dispenser dock 507 may have an alignment recess 509 for receiving and centering the container bottom 13 (see FIG. 1) such that a quick connect fitting 528 is aligned with and engages the refill station connection fitting 230 on the dispenser carbonation flow control assembly 220 (see FIG. 6). A lock release button 510 on the dispenser dock 507 may permit locking and release of the quick connect fitting 528 with the refill station connection fitting 230.

Refill gas container 510 may be arranged and adapted to contain liquified or a gaseous form of carbonation gas, such as carbon dioxide. Typically, when carbonating gas is stored in a liquid form, an upper part of the interior space of the gas container 510 will contain a supply of the gaseous form existing in equilibrium with the liquid form residing in a lower part of the interior space. Refill gas container 510 may have an outlet fitting secured to the upper portion thereof to permit supply of gaseous form of carbonation form regardless of the form stored in the container. Carbonation gas is supplied to the refill valve 526 from the refill gas container 510. A user may actuate the refill valve 526 using an actuation lever 524 once the portable carbonating dispenser 50 is locked in place. During a refill operation, carbonation gas is thus supplied from the refill gas container 510, through control valve 526 and through the onboard gas container refill manifold (FIGS. 5 and 7) in the onboard carbonation gas flow control assembly 220 to the onboard gas container 210 (FIG. 4). During refill, pressure in the onboard gas container 210 may be controlled using the relief valve 390, which may provide an audible indication to the user that the onboard container 210 has been completely refilled.

FIG. 17 illustrates an example method of filling a portable carbonating dispenser with carbonation gas using a refill station according to aspects of the disclosure. At step 1710, the onboard base liquid container 100 (FIG. 4) may be filled with a base liquid. This may be an optional step, as refill of the onboard carbonation system may occur regardless of the status of the base liquid container (full or empty). At step 1720, the portable carbonating dispenser is secured to the refill station 500, including a locking connection to the quick connect fitting 528, for example. At step 1730, a user may actuate the refill valve actuation lever 524 to cause opening of the refill valve 526 and flow of gas from the refill gas container 510 to the onboard gas container 210. At step 1740, after gas flow is discontinued, the user may remove the portable carbonating dispenser 50 from the refill station by depressing the lock release button 510, for example. At step 1750, carbonation of the base liquid may be performed on the portable carbonating dispenser by user configuration of the dispenser to a carbonation mode as described above, and user actuation of the carbonation button 262 (FIG. 1) to achieve a desired level of carbonation.

It should be understood that implementation of other variations and modifications of the aspects and embodiments described herein are intended to be part of this disclosure and the coverage intended. The scope of the invention, in its various aspects may be readily apparent to those of ordinary skill in the art, and the invention is not limited to the specific aspects or embodiments described herein, but is intended to cover any and all modifications, variations or equivalents that may be apparent from this disclosure.

1-21. (canceled)

22. A portable carbonating dispenser comprising:
a base liquid container for containing a base liquid supply;
an additive cartridge received by the base liquid container, wherein the additive cartridge at least partially extends into the base liquid container;
a carbonation gas container for containing a supply of carbonation gas; and
a carbonation flow control assembly for conveying carbonation gas from the carbonation gas container to pressurize the base liquid supply, the carbonation flow control assembly including a user-actuated flow control component for controlling a flow of carbonation gas to the base liquid supply.

23. The portable carbonating dispenser of claim 22, wherein the base liquid supply is held within an interior space of the base liquid container, and wherein at least a portion of the additive cartridge is configured to extend within the interior space.

24. The portable carbonating dispenser of claim 22, further comprising an additive cartridge secured to the base liquid container for receiving a flow of base liquid from the base liquid container and adding a flow of additive to the received flow of base liquid to form a beverage.

25. The portable carbonating dispenser of claim 22, further comprising an indicator configured to indicate the level of carbonation of the base liquid.

26. The portable carbonating dispenser of claim 25, wherein the indicator is configured to indicate the level of carbonation of the base liquid in response to a pressure of the base liquid container.

27. The portable carbonating dispenser of claim 22, wherein the additive cartridge includes an adjustment actuator to adjust an amount of additive dispensed from the additive cartridge.

28. The portable carbonating dispenser of claim 22, further comprising an isolating component configured to selectively isolate the additive cartridge from the base liquid container.

29. The portable carbonating dispenser of claim 22, wherein the additive cartridge is received by a lid of the base liquid container.

30. The portable carbonating dispenser of claim 22, wherein the base liquid container and the carbonation gas container are housed within the same enclosure.

31. A portable carbonating dispenser comprising:
a base liquid container for containing a base liquid supply;
a carbonation gas container for containing a supply of carbonation gas;
a carbonation flow control assembly for conveying carbonation gas from the carbonation gas container to pressurize the base liquid supply, the carbonation flow control assembly including a user-actuated flow control component for controlling a flow of carbonation gas to the base liquid supply; and
a relief valve adapted to maintain the base liquid container at or below a threshold pressure.

32. The portable carbonating dispenser of claim 31, wherein the relief valve is configured to open to release pressure from the base liquid container at the threshold pressure.

33. The portable carbonating dispenser of claim 31, wherein the relief valve is in fluid communication with the base liquid container and an exterior space having atmospheric pressure.

34. The portable carbonating dispenser of claim 31, the carbonation flow control assembly including a regulator adapted to regulate the carbonation gas entering the base liquid container.

35. The portable carbonating dispenser of claim 31, wherein the relief valve is adapted to provide an audible indication to a user that the carbonation gas container is full.

36. The portable carbonating dispenser of claim 31, the relief valve including a biased sealing element adapted to move in response to the threshold pressure.

37. The portable carbonating dispenser of claim 31, further comprising a lid adapted to cover the base liquid container, wherein the relief valve is positioned on the lid.

38. The portable carbonating dispenser of claim 31, wherein the relief valve is adapted to maintain a substantially constant pressure at or below the threshold pressure.

39. The portable carbonating dispenser of claim 31, wherein the threshold pressure is about 60 psi.

40. A container closure comprising:
a closure base having a journal, with a closure insert disposed therein, the closure insert having a closure insert wall defining a cartridge receiving space, the closure insert wall having at least one insert port defined thereon,
the closure insert being adapted to move to a dispensing position in which the at least one insert port permits a flow of fluid into the cartridge receiving space.

41. The container closure of claim 40, wherein the container closure is configured to receive an additive cartridge.

42. The container closure of claim 40, further comprising an indicator configured to indicate a pressure associated with the container closure.

43. The container closure of claim 40, further comprising an actuator configured to move the closure insert to the dispensing position.

44. The container closure of claim 40, wherein the container closure is configured to be received by and serve as a lid for a container.

45. The container closure of claim 43, wherein the actuator is configured to be rotatable to move the closure insert to the dispensing position.

46. The container closure of claim 40, wherein the closure insert includes an opening formed along a circular wall of the closure insert adapted to fluidly couple an interior space of the closure insert with an exterior space.

47. The container closure of claim 40, wherein the closure insert is adapted to move to a closed position and further comprising a seal configured to seal an interior space of the closure insert from an exterior space while the closure insert is in the closed position.

48. The container closure of claim 40, wherein the actuator includes a projection configured to engage with a recess on the closure insert.
